(19) United States
(12) Patent Application Publication
(10) Pub. No.: US 2021/0362435 A1
(43) Pub. Date: Nov. 25, 2021

(54) CONNECTOR, AND METHOD

(71) Applicant: MultiMaterial-Welding AG, Stansstad (CH)

(72) Inventors: Murat Tuncer, Morges (CH); Jörg Mayer, Niederlenz (CH); Gregor Eckhard, Rüschlikon (CH)

(21) Appl. No.: 17/045,794

(22) PCT Filed: Apr. 10, 2019
(86) PCT No.: PCT/EP2019/059163

§ 371 Date: Oct. 7, 2020

(30) Foreign Application Priority Data
Apr. 10, 2018 (CH) 00458/18

(51) Int. Cl. B29C 65/08; B29C 65/56; B29C 65/64; B29C 65/00; F16B 37/06; F16B 35/06

(52) U.S. Cl. CPC B29C 65/08; B29C 65/564; B29C 65/645; B29C 66/24221; B29C 66/24241; B29C 66/30325; F16B 35/06; B29C 66/7392; B29C 66/742; B29C 66/81415; B29C 66/81431; F16B 37/068; B29C 66/73116

(57) ABSTRACT

A connector, which is configured to be anchored in a first object with thermoplastic material, defines a proximodistal axis and has a plate portion extending around the proximodistal axis and having a proximal face and a distal face, the proximal face being adapted for a tool to be pressed thereagainst. The connector further includes an attachment structure accessible from the proximal side of the plate portion and/or an interaction element having a sensor and/or actuator. An anchoring skirt protrudes distally from the plate portion and distally and radially outwardly, whereby an outer pocket open towards radially outwardly is formed between the distal face of the plate portion and a proximal face of the anchoring skirt, and an inner pocket open towards distally is formed radially inwardly of the anchoring skirt. The plate portion extends radially further than the anchoring skirt.

### BACKGROUND OF THE INVENTION

### Field of the Invention

The invention is in the fields of mechanical engineering and construction, especially mechanical construction, for example automotive engineering, aircraft construction, shipbuilding, machine construction, toy construction etc.

### Description of Related Art

In the automotive, aviation and other industries, there has been a tendency to move away from steel constructions and to use lightweight material such as aluminum or magnesium metal sheets or polymers, such as carbon fiber reinforced polymers or glass fiber reinforced polymers or polymers without reinforcement, for example polyesters, polycarbonates, etc. instead.

The new materials cause new challenges in bonding elements of these materials—especially in bonding flattish object to an other object.

To meet these challenges, the automotive, aviation and other industries have started heavily using adhesive bonds. Adhesive bonds can be light and strong but suffer from the disadvantage that there is no possibility to long-term control the reliability, since a degrading adhesive bond, for example due to an embrittling adhesive, is almost impossible to detect without entirely releasing the bond.

FR 1 519 111 teaches a method of fastening a screw or similar fixation element to a thermoplastic body by applying high-frequency vibration to it to displace thermoplastic matter and cause it to flow in an interior cavity of the fixation element.

WO 2016/071 335 teaches approaches for bonding a second object with undercut surface portions to a first object including thermoplastic material by pressing the second object against the first object by a tool that is in physical contact with a coupling-in structure of the second object while mechanical vibrations are coupled into the tool until a flow portion of the thermoplastic material of the first object is liquefied and flows into the coupling structures of the second object, wherein after re-solidification of the thermoplastic material, a positive-fit connection between the first and second objects by the liquefied and re-solidified flow portion interpenetrating the coupling structures results.

The approach taught in WO 2016/071 335 works well for affixing metal objects in thermoplastic parts. However, if the first object (the thermoplastic part) is comparably thin, then either the fixation taught in WO 2016/071 335 results in a deformed side of the first object opposite the side to which the second object is attached (“underside”) or a relatively large surface area of the first object has to be subject to the attachment process. Both may be unsatisfactory, the former if the opposite surface is, for example, visible in the end product or has an other function, and the latter if there is not sufficient space and/or if the end product is expected to be subject to significant temperature variations, due to different coefficients of thermal expansion between the thermoplastic material and material of the second object.

An example is if the second object is an attachment anchor (connector) for a further part, wherein such further part may be attachable to the connector or may be pre-assembled with the connector.

### SUMMARY OF THE INVENTION

It is an object of the present invention to provide a connector for being attached to a first object including thermoplastic material, which connector overcomes drawbacks of prior art connectors. It is a further object of the invention to provide a method of bonding a second object, especially such connector, to a first object, which overcomes drawbacks of prior art methods.

According to an aspect of the invention, a connector is provided, which connector is configured to be anchored in a first object with thermoplastic material, which connector defines a proximodistal axis and includes:
A plate portion extending around the proximodistal axis and having a proximal face and a distal face,
An attachment structure accessible from the proximal side of the plate portion and/or an interaction element including a sensor and/or actuator,
An anchoring skirt protruding distally from the plate portion towards distally and radially outwardly, whereby an outer pocket open towards radially outwardly is formed between the distal face of the plate portion and a proximal face of the anchoring skirt, and an inner pocket open towards distally is formed radially inwardly of the anchoring skirt,
Wherein the connector is capable of being anchored with respect to the first object by causing a tool to press the connector against the first object while the anchoring skirt is in physical contact with the first object and while mechanical energy is coupled, for example, from the tool, into the connector until thermoplastic material of the first object flows relative to the connector and is caused to flow into the outer pocket and the inner pocket.

The fact that the anchoring skirt protruding distally from the plate portion towards distally and radially outwardly, with the outer pocket formed proximally thereof, implies that an outer face of the anchoring skirt faces towards outwardly and proximally, i.e., it has a normal pointing towards radially outwardly and proximally. An angle between the normal on the outer face and an axis of the connector (which axis will be perpendicular to the first object surface during the anchoring process) will at least at one position be substantially different from 90° for the outer pocket to be formed. For example, the minimal angle between the normal on the outer face and the axis will be at most 75° and, for example, may be between 30° and 70°.

An inner face of the anchoring skirt will face towards distally and radially inwardly. It may be conical or vaulted, especially concavely vaulted. It is not excluded, however, that the inner face may as an alternative be approximately parallel to the axis.

In embodiment, the plate portion extends radially further than the anchoring skirt.

The distal face of the plate portion may, especially if the plate portion extends radially further than the anchoring skirt, serve as a stop in the process of advancing the distal part of the connector, which includes the anchoring skirt, into material of the first object. The distal face for this does, however, not necessarily need to be essentially perpendicular to the proximodistal axis but may for example also be tapered.

The proximal face may be adapted for a tool, for example sonotrode, or a coupling element between a sonotrode and the proximal face, to be pressed against the proximal face and to thereby serve as an incoupling surface for a sonotrode (or coupling element) serving as the mentioned tool. The proximal face, or at least an outer portion thereof, may to this end be essentially plane and essentially perpendicular to the proximodistal axis. A rounded or slightly tapering shape of the incoupling surface, however, would be possible also, especially of the sonotrodrode has an accordingly shaped (rounded, tapered) surface.

A coupling element to be interposed between sonotrode and incoupling surface may, for example, be such as to prevent critical acoustic feedback from the connector back into the sonotrode. Suitable materials for such coupling element include paper, such as multi-layered paper, cardboard, etc. More in general, the coupling element may include paper, cardboard and/or plastics either thermoplastic or thermosetting.

In embodiments, a thermoplastic washer is used as such coupling element. Especially, such thermoplastic washer may be of a material capable of being welded to material of the first object—for example the same material as the first object. Such thermoplastic washer in addition to serving for guiding the connector during the anchoring process may ensure additional fixation in areas where coming in contact with the first object.

In addition to providing an additional coupling and structural stability, this optional concept may yield the function of providing a sealing. Sealing could be for example be advantageous in configurations involving carbon fibre reinforced thermoplastics where moisture can have an influence on galvanic corrosion.

As yet another alternative, instead of from the proximal side, energy may be coupled into the arrangement from the distal side, through the first object. To this end, the connector and the first object may be pressed against each other while energy is coupled into the first object from a (distal) surface of the first object which is opposite the (proximal) surface against which the connector is pressed. In an example, the anchoring step may include pressing the first object and the connector against each other by positioning the first object and the connector between a sonotrode and a third object to which the connector is mounted.

Also in embodiments according to this alternative, a coupling element to be interposed between sonotrode and incoupling surface (of the first object) can be used, in order to eliminate or at least reduce marks stemming from the sonotrode on the first object.

The outer pocket runs around the anchoring skirt, is confined towards radially inwardly and towards distally by the anchoring skirt, towards proximally (and possibly radially inwardly also) by the plate portion and is open towards radially outwardly.

The anchoring skirt may extend uninterruptedly around a skirt axis, i.e., form an uninterrupted collar extending by 360°. Alternatively, the anchoring skirt may be interrupted and be formed by a plurality of discrete anchoring skirt portions. In an example, such discrete anchoring skirt portions may form 3 feet, each forming a segment of about 60°, with 60°-gaps between them. The skirt axis may be the proximodistal axis of the connector, in which case the connector may include one single anchoring skirt. Alternatively, the skirt axis may be off-center, but parallel to the proximodistal axis. It is possible that the connector may include a plurality of the anchoring skirts, each extending—uninterruptedly or possibly interruptedly—around an axis.

It has been found that this construction makes the connector especially suited for being anchored in an object having thermoplastic material, especially—but not only—if this object or a thermoplastic portion thereof is comparably thin, i.e. has a small extension along the proximodistal axis.

Firstly, the outer pocket and the inner pocket may accommodate the thermoplastic material displaced by the anchoring skirt. Thereby, especially the inner pocket serves for preventing that a hydrostatic pressure during the process becomes too high. Such high hydrostatic pressure would have the potential of acting against a stable anchoring and/or of causing inner stress and/or deformation of the first object.

Secondly, it has been found that by the anchoring skirt extending towards distally and radially outwardly, it has to penetrate only little into the material of the first object to achieve sound anchoring. This on the one hand makes comparably short processing times possible. Secondly, a surface on the distal side of the first object tends to be unaffected or affected only little because of this construction of the connector. Nevertheless, the footprint is relatively large, and thus the connection of the connector to the first object may not only withstand axial forces but also, to some extent, tilting forces. This effect of withstanding tilting forces may be enhanced if the plate portion is shaped so that its shape causes it to be supported by the first object, especially in radially peripheral positions.

In a first group of embodiments, the anchoring skirt is rotationally symmetrical, for example extending around the (central) proximodistal axis.

In a second group of embodiments, the anchoring collar is not rotationally symmetrical about the proximodistal axis, whereby the connector is, after anchoring, secured relative to the first object also against twisting movements by a positive fit connection.

For example, the anchoring skirt may extend in a collar-like manner around the proximodistal axis but may have a structure that includes at least one radial indentation or protrusion, or being interrupted as a function of the circumferential angle. Alternatively, it may have a basic structure that does not follow a circular contour but that is, for example, polygonal, multi-lobed, elliptical etc. In addition or as an even further alternative, the connector may have a plurality of anchoring skirts each extending (symmetrically or in an asymmetric manner) around its anchoring skirt axis, wherein at least one of the anchoring skirt axes does not coincide with the central proximodistal axis of the connector.

In embodiments, the anchoring skirt ends distally in an edge, whereby the connector when brought into contact with a proximally facing plane surface of the first object touches the first object along a line defined by the edge. As such, the edge may firstly serve as energy director. Secondly, an edge may serve for guiding volume portions of the flowable thermoplastic material towards inwardly and outwardly, respectively. A distal edge formed by the anchoring skirt will in many embodiments be the distal-most feature of the connector. By extending along a contour (which may be circular or not circular, as discussed hereinbefore), the distal edge also defines a support for the connector relative to the first objet at the onset of the anchoring process, at least of the first object has a generally flat proximal surface portion.

In embodiments, proximally of the inner pocket a flow hole extending into a connector body is formed. Such a flow hole may serve as kind of overflow volume for thermoplastic material that is liquefied during the anchoring process and that is displaced, by the anchoring skirt, towards inwardly. The inner (proximal) end of such flow hole may be, especially in an embodiment in which a hydrostatic pressure on the thermoplastic material is to be avoided, for example if the first object is comparably thin and/or the proximal surface and/or the other (distal) surface needs to be kept free of deformations, proximally of the proximal surface of the first object at the end of the process, and thermoplastic material may flow backwards towards proximally during the process. Depending on the application, it is possible also that the flow hole is a through hole, thus a hole with no inner end.

The connector may optionally have, in the region of the inner pocket and/or, if applicable, in the flow hole, structures that are possibly undercut with respect to axial directions and into which the thermoplastic material may flow to add, after re-solidification, to the tensile stability of the connection between the connector and the first object. Such undercut structures may be macroscopic and/or may be formed by a substantial surface roughness of for example Rₐ>10 μm (Rₐ being the standard average roughness).

Especially such structures in the anchoring skirt may be efficient because in the anchoring process the anchoring skirt will be comparably hot, and thus even fine structures may be interpenetrated by flowable thermoplastic material.

In embodiments such an undercut structure is defined by at least one neck formed by the flow hole, for example adjacent its distal mouth.

The connector may have an attachment structure that is suitable for fastening a further, third object to the first object if the connector is anchored relative to the first object. Thereby, the connector may serve as anchor/fastener for such third object. An example of such attachment structure is a threaded bar that is, for example, integral with a connector body that includes the plate portion and with which the anchoring skirt may also be integral. Alternative attachment structures are possible also, including a nut, a snap-on structure, a bayonet coupling piece, etc. In many embodiments, including embodiments with a thread or a bayonet coupling piece or a snap-on structure, the attachment structure is undercut with respect to axial directions. The attachment structure may be accessible from the proximal side for the third object to be brought in contact therewith.

In many embodiments, the attachment structure, for example threaded bar, bar with an inner thread (nut), etc., the attachment structure protrudes above the proximal face of the plate portion to distally. Especially, the plate portion may be comparably thin and mainly serve for stabilizing against tilting movements after the anchoring process. The connector may then, when fastened to the first object have the plate portion that is almost flush or entirely flush with the proximal surface of the first object, and with the attachment structure protruding proximally from the assembly of the first object and plate portion.

In embodiments, the plate portion may instead of being integral with the anchoring skirt be of a different material, especially of a thermoplastic material. For example, such thermoplastic material of the plate portion may be weldable to the first object (for example the thermoplastic material may be the same as the thermoplastic material of the first object). In these embodiments, the anchoring process may in addition to the anchoring of the anchoring skirt result in a weld between the first object and the plate portion.

The sonotrode (or other tool) that is used to couple the pressing force and mechanical vibration energy into the connector may have an axial channel for accommodating the attachment structure, with the outcoupling surface running around the axial channel. Optionally, the sonotrode may further include a holding mechanism to hold the shaft portion in the axial channel. Such holding element may be a resilient element arranged in the channel, for example in an axial position constituting a vibrational node. Alternatively, it may include a holding body mounted relative to the sonotrode via a spring, the holding body cooperating with a guiding structure of the connector that belongs to the part of the connector that extends into the axial channel of the sonotrode. Such holding body may have an at least partially spherical surface and/or the guiding structure may include an indentation. In addition or as an even further alternative, a holding mechanism may include a suction arrangement to generate an underpressure in the channel.

In embodiments, the sonotrode has a sonotrode body and an exchangeable sonotrode tip that has the distal outcoupling face and the axial channel. Such exchangeable sonotrode tip may have a thread or other feature for attaching to the sonotrode body. This allows to combine a generic sonotrode body with several connector specific and different sonotrode tips. Also, it allows to exchange the sonotrode tip after exposure to substantial wear without having to exchange the entire sonotrode.

Instead of or alternatively to an attachment structure, the connector may contain the part to be fastened to the first object, for example in the form of an interaction element being a sensor and/or actuator.

The method of anchoring a connector relative to a first object includes the steps of providing the connector as described in this text, of positioning the connector relative to the first object so that the anchoring skirt is in contact with a thermoplastic portion of the first object, of pressing the connector against the first object and coupling mechanical energy into the connector and/or into the first object until thermoplastic material of the first object becomes flowable and flows into the first and second pockets, and of stopping the energy input, whereby after re-solidification of the flow portion of the thermoplastic material the connector is anchored relative to the first object by the anchoring skirt being embedded in re-solidified thermoplastic material of the first object.

Making the flow portion flowable in this is primarily caused by friction between the connector subject to the mechanical energy input on the one side and the surface of the first object on the other side, which friction heats the first object superficially.

Pressing and coupling energy into the connector may at least partially be done simultaneously. In many embodiments, the pressing force is maintained for some time after the energy input stops.

The mechanical energy may be mechanical vibration energy. Then, the pressing force and the energy may both be coupled into the connector by a sonotrode pressed against the proximal face of the plate portion.

Alternatively, the mechanical energy may be mechanical rotation energy. Then, a rotating tool that is rotationally coupled to the connector is used to couple the energy and the pressing force into the connector.

The connector, or at least the anchoring skirt thereof, may be of a material that is not liquefiable. This definition includes the possibility that the material is liquefiable at a substantially higher temperature than the material of the first object, such as a temperature higher by at least 50°. In addition or as an alternative, the condition may hold that at a temperature at which the first object's thermoplastic material is flowable, the viscosity of the material of the connector is higher than the viscosity of the thermoplastic material of the first object by orders of magnitude, for example by at least a factor between 10³ and 10⁵. In addition or as an alternative to including a different liquefiable matrix material with a different liquefaction temperature and/or different glass transition temperature, this can also be achieved by a higher filling grade of for example a fiber filler.

Especially, in embodiments the connector or at least the anchoring skirt thereof may consist of metal and/or other hard materials (glasses, ceramics, etc.) and/or thermosetting plastics and/or thermoplastics that remain below their glass transition temperature during the entire process.

The present invention also concerns a set of a connector, as described in this text, together with a sonotrode or sonotrode tip adapted to couple mechanical vibration energy and a pressing force into the connector or holding tool for coupling a counter force to the pressing force (which together with the vibrations then is applied onto the first object from distally). Especially, such sonotrode, sonotrode tip or holding tool may have an axial channel for accommodating any central portion of the connector, especially the attachment structure, whereas a peripheral portion of the sonotrode, sonotrode tip or holding tool cooperates with the proximal face of the plate portion. The sonotrode, sonotrode tip or holding tool may further be equipped for a holding mechanism as mentioned hereinbefore.

In this text, the liquefaction temperature or the temperature at which a thermoplastic material becomes flowable is assumed to be the melting temperature for crystalline polymers, and for amorphous thermoplastics a temperature above the glass transition temperature at which the becomes sufficiently flowable, sometimes referred to as the ‘flow temperature’ (sometimes defined as the lowest temperature at which extrusion is possible), for example the temperature at which the viscosity drops to below 10⁴ Pa*s (in embodiments, especially with polymers substantially without fiber reinforcement, to below 10³ Pa*s).

For applying a counter force to the pressing force, the first object may be placed against a support, for example a non-vibrating support. According to a first option, such a support may include a supporting surface vis-à-vis the spot against which the first object is pressed, i.e. distally of this spot. This first option may be advantageous because the bonding can be carried out even if the first object by itself does not have sufficient stability to withstand the pressing force without substantial deformation or even defects.

According to a second option, the distal side of the first object may be exposed, for example by the first object being held along the lateral sides or similar. This second option features the advantage that the distal surface will not be loaded and will remain unaffected if the connector does not reach to the distal side.

In embodiments, the first object is placed against a support with no elastic or yielding elements between the support and the first object, so that the support rigidly supports the first object.

In a group of embodiments, the first object is a flattish object, such as a polymer plate, for example a polymer cover.

In this text the expression “thermoplastic material being capable of being made flowable, e.g., by mechanical vibration” or in short “liquefiable thermoplastic material” or “liquefiable material” or “thermoplastic” is used for describing a material including at least one thermoplastic component, which material becomes liquid (flowable) when heated, in particular when heated through friction, i.e., when arranged at one of a pair of surfaces (contact faces) being in contact with each other and vibrationally moved relative to each other, wherein the frequency of the vibration has the properties discussed hereinbefore. In some situations, for example if the first object itself has to carry substantial loads, it may be advantageous if the material has an elasticity coefficient of more than 0.5 GPa. In other embodiments, the elasticity coefficient may be below this value, as the vibration conducting properties of the first object thermoplastic material do not play a role in the process. The above-mentioned conditions, for example an elasticity coefficient of more than 0.5 GPa could be advantageous also for a washer or thermoplastic plate portion of the above-discussed kind.

Thermoplastic materials are well-known in the automotive and aviation industry. For the purpose of the method according to the present invention, especially thermoplastic materials known for applications in these industries may be used.

A thermoplastic material suitable for the method according to the invention is solid at room temperature (or at a temperature at which the method is carried out). It preferably includes a polymeric phase (especially C, P, S or Si chain based) that transforms from solid into liquid or flowable above a critical temperature range, for example by melting, and re-transforms into a solid material when again cooled below the critical temperature range, for example by crystallization, whereby the viscosity of the solid phase is several orders of magnitude (at least three orders of magnitude) higher than of the liquid phase. The thermoplastic material will generally include a polymeric component that is not cross-linked covalently or cross-linked in a manner that the cross-linking bonds open reversibly upon heating to or above a melting temperature range. The polymer material may further include a filler, e.g. fibres or particles of material that has no thermoplastic properties or has thermoplastic properties including a melting temperature range which is considerably higher than the melting temperature range of the basic polymer.

In this text, generally a “non-liquefiable” material is a material that does not liquefy at temperatures reached during the process, thus especially at temperatures at which the thermoplastic material of the first object is liquefied. This does not exclude the possibility that the non-liquefiable material would be capable of liquefying at temperatures that are not reached during the process, generally far (for example by at least 80° C.) above a liquefaction temperature of the thermoplastic material or thermoplastic materials liquefied during the process. The liquefaction temperature is the melting temperature for crystalline polymers. For amorphous thermoplastics the liquefaction temperature is a temperature above the glass transition temperature at which the becomes sufficiently flowable, sometimes referred to as the ‘flow temperature’ (sometimes defined as the lowest temperature at which extrusion is possible), for example the temperature at which the viscosity drops to below 10⁴ Pa*s (in embodiments, especially with polymers substantially without fiber reinforcement, to below 10³ Pa*s)), of the thermoplastic material.

For example, the non-liquefiable material may be a metal, such as aluminum or steel, or wood, or a hard plastic, for example a reinforced or not reinforced thermosetting polymer or a reinforced or not reinforced thermoplastic with a melting temperature (and/or glass transition temperature) considerably higher than the melting temperature/glass transition temperature of the liquefiable part, for example with a melting temperature and/or glass transition temperature higher by at least 50° C. or 80° C.

Specific embodiments of thermoplastic materials are: Polyetherketone (PEEK), polyesters, such as polybutylene terephthalate (PBT) or Polyethylenterephthalat (PET), Polyetherimide, a polyamide, for example Polyamide 12, Polyamide 11, Polyamide 6, or Polyamide 66, Polymethylmethacrylate (PMMA), Polyoxymethylene, or polycarbonateurethane, a polycarbonate or a polyester carbonate, or also an acrylonitrile butadiene styrene (ABS), an Acrylester-Styrol-Acrylnitril (ASA), Styrene-acrylonitrile, polyvinyl chloride, polyethylene, polypropylene, and polystyrene, or copolymers or mixtures of these.

In embodiments in which both, the first object and the connector include thermoplastic material, the material pairing is chosen such that the flow temperature of the connector material is substantially higher than the flow temperature of the first object material, for example higher by at least 50°. Suitable material pairings are, for example, polycarbonate or PBT for the first object and PEEK for the connector.

In addition to the thermoplastic polymer, the thermoplastic material may also include a suitable filler, for example reinforcing fibers, such as glass and/or carbon fibers. The fibers may be short fibers. Long fibers or continuous fibers may be used especially for portions of the first object and/or of the connector that are not liquefied during the process.

The fiber material (if any) may be any material known for fiber reinforcement, especially carbon, glass, Kevlar, ceramic, e.g. mullite, silicon carbide or silicon nitride, high-strength polyethylene (Dyneema), etc.

Other fillers, not having the shapes of fibers, are also possible, for example powder particles.

Mechanical vibration or oscillation suitable for those embodiments of the method according to the invention that include coupling mechanical vibration energy into the connector, preferably a frequency between 2 and 200 kHz (even more preferably between 10 and 100 kHz, or between 20 and 40 kHz) and a vibration energy of 0.2 to 20 W per square millimeter of active surface. The vibrating tool (e.g., sonotrode) is, e.g., designed such that its contact face oscillates predominantly in the direction of the tool axis (longitudinal vibration) and with an amplitude of between 1 and 150 μm or 100 μm, preferably around 30 or 50 to 100 μm, for example around 60 to 90 μm. Such preferred vibrations are, e.g., produced by ultrasonic devices as, e.g., known from ultrasonic welding.

In this text, the terms “proximal” and “distal” are used to refer to directions and locations, namely “proximal” is the side of the connector facing away from the first object, whereas distal is the opposite side. The “axis” is the proximodistal anchoring axis along which the pressure in the step of pressing is applied. In many embodiments, the mechanical vibrations are longitudinal vibrations with respect to the axis.

### BRIEF DESCRIPTION OF THE DRAWINGS

In the following, ways to carry out the invention and embodiments are described referring to drawings. The drawings are schematical. In the drawings, same reference numerals refer to same or analogous elements. The drawings show:

FIG. 1 a side view of a connector;

FIG. 2, in part, the connector of FIG. 1 in section;

FIG. 3 a side view of a further connector;

FIG. 4, in part, the connector of FIG. 3 in section;

FIG. 5 a view of yet another connector;

FIG. 6 a view of an even further connector;

FIG. 7, in cross section a configuration of a first object, a connector and a sonotrode;

FIG. 8 the connector of FIG. 7 anchored with respect to the first object;

FIG. 9 a schematical bottom view of an even further connector;

FIG. 10 a partial section of a variant of a connector anchored with respect to a first object;

FIG. 11 a (partial) view of a further connector;

FIG. 12 a partial section of an even further rconnector;

FIG. 13 a schematic cross section of a sonotrode with a connector;

FIG. 14 a section through an alternative configuration of a connector, first object, and sonotrode;

FIGS. 15 and 16 views of further connectors in section;

FIG. 17 a configuration, in section, of an even further configuration of a connector, object, and sonotrode, further with a washer;

FIG. 18 a section through the configuration of FIG. 17 without the sonotrode after the anchoring process;

FIG. 19, in section, an even further, hybrid, connector; and

FIGS. 20 and 21 views of sonotrode tips depicted in section along a plane through which the axis runs.

### DESCRIPTION OF THE PREFERRED EMBODIMENTS

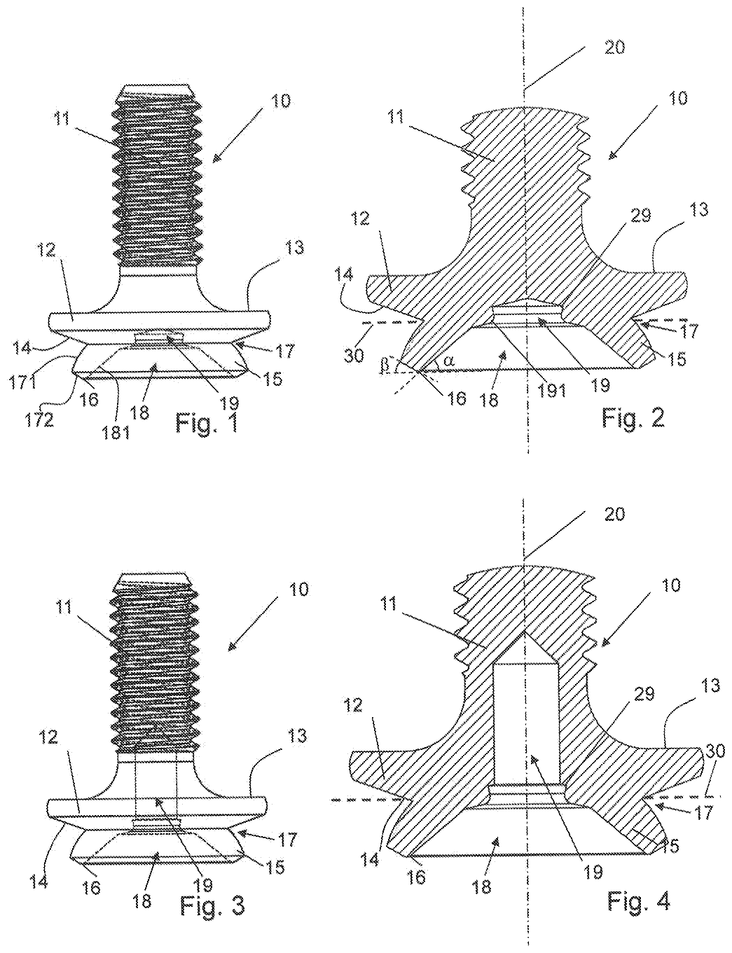

The connector 10 of FIGS. 1 and 2 serves as anchor for a third object (not shown) to be fastened to the first object having thermoplastic material. To this end, the connector 10 has an attachment structure 11 in the form of a threaded bar. The threaded bar is arranged centrally with respect to the proximodistal axis 20 and extends proximally from a plate portion 12.

The connector is, for example, metallic or of plastic (thermosetting or thermoplastic) or possibly of ceramics. If the connector is liquefiable, the liquefaction temperature is such that it is not flowable at temperatures at which the thermoplastic of the first object is flowable. For example, the temperature at which material of the connector may become flowable, if at all, is higher than the melting temperature of the first material by at least 50° or at least 80° C.

The plate portion 12 forms a proximal face 13 that may serve as incoupling surface for a sonotrode by which a pressing force and mechanical vibration are coupled into the connector. The plate portion 12 also forms a distal face 14.

The proximal face 13 has an outer portion that is essentially plane and perpendicular to the proximodistal axis 20, whereby the coupling with the sonotrode is particularly efficient. A rounded or slightly tapering shape of the incoupling surface, however, would be possible also.

Distally of the plate portion 12, the anchoring skirt 15 protrudes towards distally and radially outwardly. The anchoring skirt distally ends in an edge 16. In the anchoring process, the edge firstly serves as energy director. Secondly, the edge serves for guiding volume portions of the flowable thermoplastic material towards inwardly and outwardly, respectively. The inclination angles α, β of the tapers of the inner and outer faces 181, 172 leading to the edge from inwardly and from outwardly, respectively, may be similar, as in the illustrated embodiment, but may also be different. For example, the inclination angles may be, in the definition according to FIG. 2, between 20° and 60°, and/or they may differ from each other by not more than 20°. It is also possible that at least one of the angles, especially the angle β is more than 60°, for example up to 90° or even higher than 90° (of course, only one of the angles α, β can be higher than 90°).

The sharpness of the edge 16, i.e. the angle 180°-α-β is also a potentially important parameter. It has been found that sharp edge angles 180°-α-β make fixation without any undesired (depending on the particular application) angles easier to achieve. For example, in embodiments the edge angle may be chosen to be at most 120°, at most 90° or for example (in embodiments different from the one shown in FIG. 4) even at most 60°, at most 50° or less.

Between the plate portion 12 and the anchoring skirt, particularly between the distal face 14 and an outer face 171 of the anchoring skirt 15 an outer pocket 17 is formed. The outer pocket 17 runs around the anchoring skirt 15, is confined towards radially inwardly and towards distally by the anchoring skirt, towards proximally and radially inwardly by the plate portion (inner part of distal face 14) and is open towards radially outwardly.

For forming the pocket 17 together with the plate portion 15, the outer face 171 of the anchoring skirt faces towards outwardly and proximally, i.e., it has a normal pointing towards radially outwardly and proximally.

Radially inwardly of the anchoring skirt, an inner pocket 18 is formed. The inner pocket is confined towards radially outwardly by the anchoring skirt 15 and is open towards distally. Towards proximally, the inner pocket is partially confined by the plate portion. However, from the inner pocket, a flow hole 19 (having a flow hole mouth 191) extends towards proximally into the body of the connector. The flow hole 19 serves for accommodating material of the first object that has been displaced towards inwardly by the anchoring skirt. In FIG. 2, a level 30 to which the connector is anchored relative to the first object is depicted (level 30 shows the approximate position of the proximally facing surface of the first object relative to the connector after the anchoring process, the level being mainly defined by the shape of the connector). The inner end of the flow hole 19 is generally proximally of the level, so that there can be a backflow towards proximally of material displaced towards inwardly by the anchoring skirt.

A further function of the inner pocket and/or of a flow hole may be to yield additional tensile strength by providing structures into which the thermoplastic material may flow and that yield, after re-solidification, a further positive fit. In FIGS. 1 and 2, as well as in FIGS. 3 and 4 described hereinafter, there is illustrated a slight undercut 29 of the flow hole. By the thermoplastic material penetrating therein, this kind of additional tensile strength (strength of the connection against axial pulling forces) is caused. The inner pocket and/or the flow hole may include further undercut structures as explained hereinafter.

The variant of FIGS. 3 and 4 distinguishes from the embodiment of FIGS. 1 and 2 mainly in that the flow hole extends further towards proximally, whereby there is essentially no restriction on the volume of thermoplastic material displaced inwardly and being caused to flow back. This embodiment is suited for anchoring the connector somewhat deeper (see level 30) in the first object, compared to the embodiment of FIGS. 1 and 2.

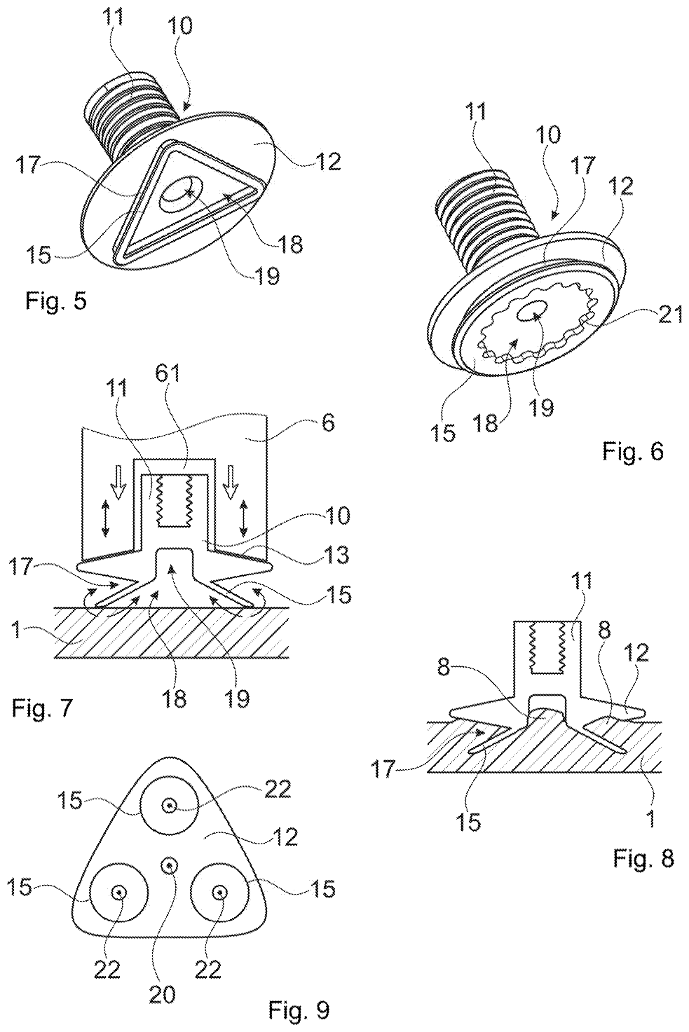

In the embodiment of FIG. 5, the anchoring skirt 15 is not round (not circularly symmetrical about the proximodistal axis) but has a generally polygonal shape, namely a triangular shape. Any shape that is not symmetrical about the proximodistal axis may be advantageous in situations where the connector does not only have to take up axial loads with respect to the first object but potentially also torques around the proximodistal axis, for example during a process of fastening a third object to the first object.

Also the embodiment of FIG. 6 has an anchoring skirt 15 with shape that is not circularly symmetrical about the proximodistal axis. More in concrete, the anchoring skirt has inner structures 21 of a pattern of radial indentations and protrusions.

In addition or as an alternative, the anchoring skirt could also have outer such structures.

In FIGS. 7 and 8, very schematically a process of anchoring a connector 10 with respect to a first object 1 is illustrated. The first object 1 is illustrated to be a relatively thin plate of thermoplastic material.

The connector 10 shown in FIGS. 7 and 8 has the following features that are distinct it from the embodiments of FIGS. 1-4:
The attachment structure 11 does not include a bar with an outer thread but has an inner thread. Generally, the attachment structure may be formed in any suitable manner. As alternatives to an (outer or possibly inner) thread, the attachment structure could also be shaped for a bayonet coupling, a snap-on connection, etc.
The proximal face 13 is not perpendicular to the proximodistal axis but is slightly sloped.

These features are independent of each other, and the process described hereinafter is independent of them. The process may apply to all embodiments of connectors referred to in this text.

For anchoring, a sonotrode 6 having an axial channel 61 for accommodating the attachment structure 11 and having an outcoupling face adapted to the proximal face 13 of the connector presses the connector against the first object, with the anchoring skirt 15 in physical contact with the first object, while mechanical vibrations are coupled into the connector by the sonotrode. This is done until thermoplastic material of the first object in contact with the connector becomes flowable and by the pressing force is caused to flow relative to the connector, see arrows in FIG. 7. After the mechanical energy input by the mechanical vibrations stops, the sonotrode 6 may be used to apply some after pressure, for example until re-solidification of the flowable portions has set in to at least some extent.

FIG. 8 shows the connector anchored after the process, with the thermoplastic material after re-solidification securing the connector to the first object in a positive-fit manner. Especially, material flown into the outer pocket 17 secures the connector against axial movements towards proximally. The (re-solidified) flow portion 8 of the thermoplastic material includes material that has flown back to proximally of the proximal surface (level 30/FIGS. 2 and 4) of the first object.

FIG. 9 shows an embodiment with a plate portion 12 and a plurality of anchoring skirts 15, each extending around an anchoring skirt axis 22. The attachment structure (not visible in FIG. 9) may be, similarly as in the embodiments described hereinbefore, symmetrical about the central proximodistal axis 20.

Whereas the embodiments shown in the figures have attachment structures, alternatively or in addition thereto the connector could also have an integrated interaction element being a sensor and/or actuator.

The method of anchoring the connector relative to the first object may include coupling the mechanical energy into the connector in the form of vibration energy, as described referring to FIG. 7. Such vibration may be longitudinal vibration. Alternatively, the vibration may include rotational vibration, wherein the connector vibrates by rotating back and forth around the proximodistal axis. As yet another alternative, the mechanical energy could be mechanical rotation energy, wherein the connector is caused to be subject to a rotational movement around the proximodistal axis, relative to the first object. Of the above described embodiments, with the exception of the connectors of FIG. 5 and of FIG. 9, all embodiments are potentially suited for this variant of the anchoring process.

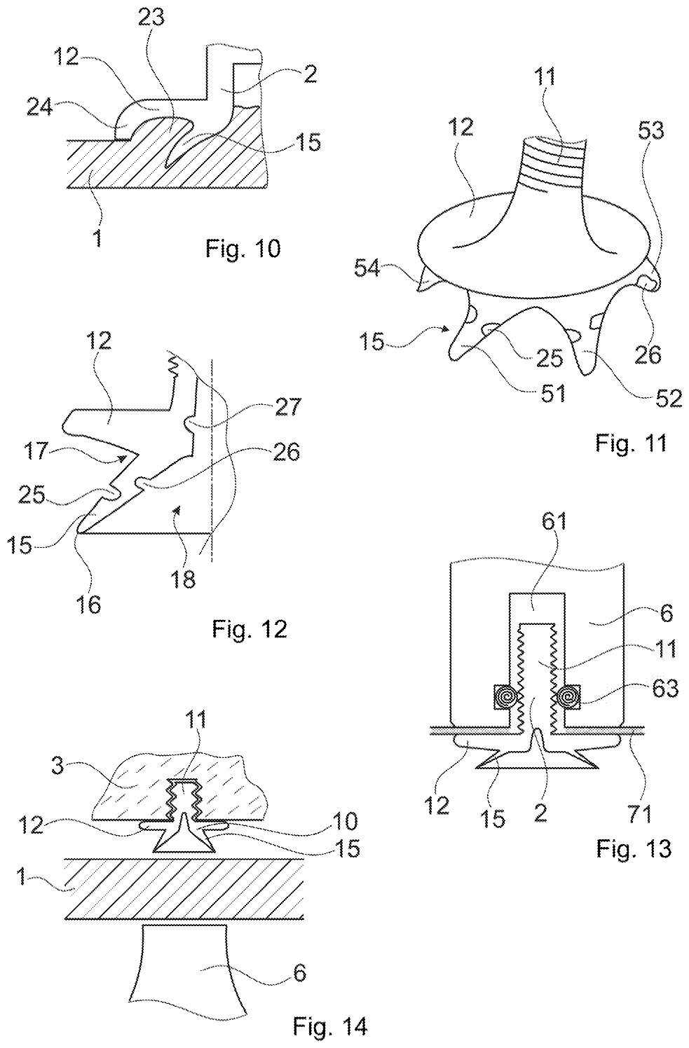

FIG. 10 shows a partial section of a connector 2 anchored with respect to a first object 1. The plate portion 12 has a circumferential distal protrusion 24 that forms a chamber 23 for the thermoplastic material that has flown back towards proximally. Thereby, the stability against tilting forces may be enhanced by at least one of:
The circumferential distal protrusion itself abutting against the first object after anchoring;
The thermoplastic material having flown as far as the plate portion thus, for example, essentially filling the chamber so that after re-solidification of the thermoplastic material the plate portion abuts against thermoplastic material.

FIG. 11 shows an embodiment of a connector that is distinct from the embodiments previously described in that the anchoring skirt 15 is does not extend around a full circumference but is interrupted to have a plurality of anchoring skirt portions 51, 52, 53, 54.

Independently of this feature, FIG. 11 also shows optional indentations 25, 26 as described hereinafter.

FIG. 12, schematically showing a partial section of a connector, illustrates possible undercut structures that may add to the stability of the anchoring. First indentations 25, being open towards the outer pocket, are arranged on a radial outer portion of the anchoring skirt 15. Second indentations 26, open towards the inner pocket, are arranged on a radial inner portion of the anchoring skirt 15. Third indentations 27 are arranged around the flow hole. At least the second and third indentations may be undercut with respect to axial directions.

Generally, a connector can have first indentations, second indentations and/or third indentations, i.e., these structures are possibly independent of each other. Also, in addition or as an alternative to the indentations other structures, such as protrusions, (circumferential ridges for example), roughness, etc., may be present.

FIG. 13 shows a holding mechanism for holding the connector 2 relative to the sonotrode 6. In the depicted embodiment, the holding mechanism includes a resilient element 63 arranged in an axial position constituting a vibrational node.

FIG. 13 further illustrates, independently of the holding mechanism, a coupling element interposed between sonotrode 6 and incoupling surface, for example a sheet of (for example multi-layered) paper or cardboard. Such sheet may also be used for being provisionally mounting a plurality of connectors in a, for example, industrial process that involves anchoring many connectors.

FIG. 14 shows the option of coupling mechanical vibration energy into the system by causing a sonotrode 6 to impinge on the first object from the opposing, distal side while the connector 2 and the first object 1 are held against each other. This option may especially be attractive if the distal surface of the first object does not have to have a perfect quality after the process but for example is concealed in the final article to be produced. However, using appropriate measures it may also be possible to use this option in cases where the distal surface of the first object is, for example, a class A surface—for example a protective foil between the first object and the sonotrode. In fact, it has been shown experimentally that in some situations this option of coupling the mechanical energy into the assembly from a distal side, by a sonotrode impinging on the first object instead of on the connector, is even more secure in terms of making an anchoring without any marks on the distal first object surface possible. In embodiments in which the connector serves for securing a further, third object to the first object 1, the configuration with energy input from the distal side may have the advantage that the connector(s) can be pre-mounted on the third object 3, prior to the anchoring process. For example, if the connection between the third object 3 and the connector is a screwed connection, multiple connectors 2 can be directly screwed into/onto the respective anchoring locations of the third object, this not being possible any more after the connectors have been anchored. FIG. 14 illustrates the third object 3 with a fastening hole having an inner thread and with the threaded bar 11 of the connector screwed into the fastening hole.

Other holding methods than holding by a screwed connection are possible also. Generally, in many embodiments holding should ensure directional stability of the connector with respect to the tool or third object that holds it and a good coupling between the connector and the tool/third object.

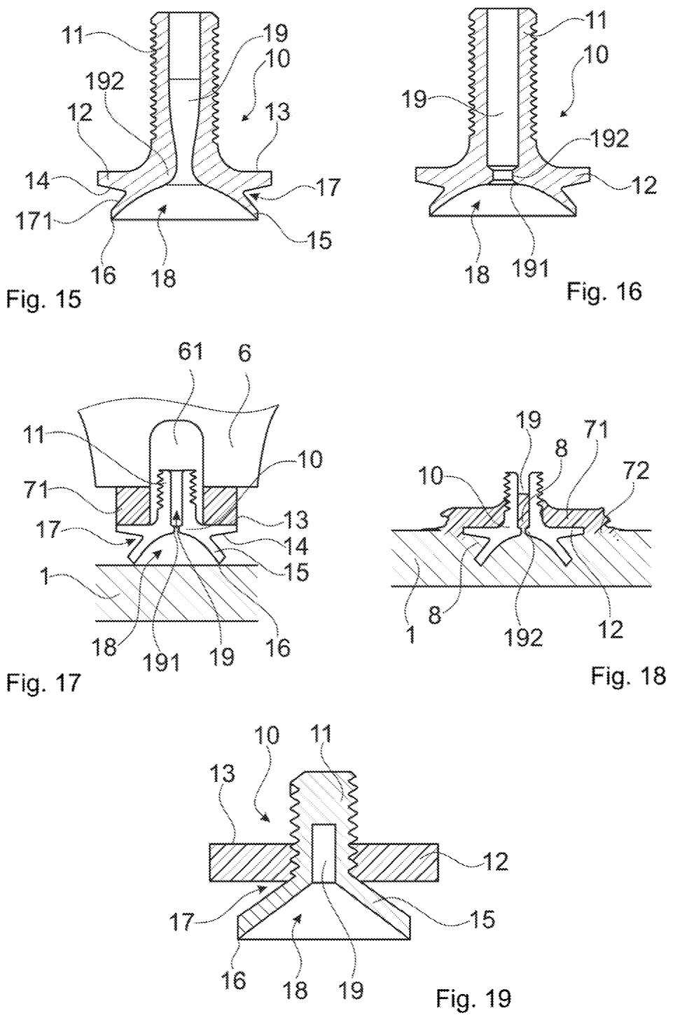

FIG. 15 depicts a connector 10 that, in contrast to the previously described embodiments, has the following properties:
The flow hole 19 is a through hole extending through the entire attachment structure 11 to the proximal end of the connector.
The flow hole has a restriction 192 whereby, like in the embodiments of FIGS. 4 and 12, an undercut with respect to axial directions is formed. Hence, thermoplastic material that during the anchoring process flows back into the flow hole beyond the restriction 192 after re-solidification contributes to the anchoring by causing a positive fit connection.

These two features can be realized independent of each other. Especially, a flow hole 19 that is not a through hole but a blind hole open only at the distal mouth 191 can be undercut, too. Similarly, it is possible to have a flow hole 19 that is a through hole but that is not undercut.

In the variant shown in FIG. 16, the restriction (neck) of the flow hole 19 in contrast to FIG. 15 is not continuous but is stepped so that a proximally facing shoulder is formed within the flow hole.

Generally, the restriction (neck) of the flow hole can be adjacent the distal mouth 191. It would also be possible to make a restriction more proximally, in addition or as an alternative to the neck adjacent the distal mouth.

Other structures that cause a positive fit with respect to axial directions would be possible also, including for example a series of circumferential ridges, an arrangement of inwardly facing humps, or an inner thread.

A further optional feature of both, the embodiment of FIG. 15 and of FIG. 16 (which feature is again independent of the other features of these embodiments) is that the distal edge 16 is relatively sharp in that the angle 180°-α-β is acute and is, for example, less than 60°. In the shown embodiment, the connector has adjacent the proximally outer face 171 of the anchoring skirt a steeper, for example cylindrical, surface.

In the embodiment shown in FIG. 17, for anchoring in addition to the elements described hereinbefore a washer 71 is used. The washer in this embodiment is of the same thermoplastic material as the first object 1 or is of a different thermoplastic material that however is weldable to the material of the first object.

For anchoring, the mechanical vibrations are coupled into the connector via the washer that abuts against the proximal face 13 and is pressed thereagainst by the vibrating sonotrode. This will cause, initiated by the sharp edge 16 at the distal end serving as energy director the local liquefaction of thermoplastic material of the first object 1 and the effects described hereinbefore referring to FIGS. 7 and 8. When during the process and after the anchoring skirt 15 has penetrated into the first object the distal face 14 is pressed against the surface of the first object the mechanical resistance increases. In the embodiment shown in FIG. 17 the pressing force and the vibrations are nevertheless maintained until material of the washer 71 becomes flowable. This may be continued until material of the washer and of the first object 1 are welded to each other (weld 72) around a periphery of the plate portion 12, as shown in FIG. 18. This will in addition to making a contribution to the fastening strength also cause the interface between the plate portion and the first object to be sealed.

FIG. 18 also illustrates a part of the flow portion 8 in the flow hole 19 proximally of the restriction 192.

The-optional-use of a washer 71, for example leading to a weld around a periphery of the plate portion 15, is an option for all embodiments of the present invention and is not restricted to the particular shape and features of the connector illustrated in FIGS. 17 and 18.

An embodiment of a connector 10 of a non-homogeneous material composition is shown in FIG. 19. In this embodiment, the connector has a metallic body forming the attachment structure 11 and the anchoring skirt 15 and further has a thermoplastic plate portion 12 firmly axially coupled (in FIG. 19 by an outer thread of the metallic body) to the metallic body. The thermoplastic plate portion may be of a same thermoplastic material as the first object or of an other thermoplastic material weldable to the thermoplastic material of the first object.

The anchoring process for such a hybrid connector 10 is carried out similar to the process with the connectors described hereinbefore. During an initial phase when the vibration is coupled into the assembly via the proximal face 13 thermoplastic material of the first object in contact with the relatively sharp edge is liquefied due to the energy directing properties. As soon as the mechanical resistance becomes higher, material of the thermoplastic plate portion is liquefied also, possibly resulting in a weld between the plate portion and the first object. Advantages of this weld may be comparable to the advantages of the weld with a thermoplastic washer, as illustrated in FIG. 18, though without the additional anchoring strength caused by the metallic plate portion of the embodiment of FIG. 18. During the anchoring process, especially towards its end, the connection between the metallic body and the thermoplastic plate portion may loosen to some extent because of thermoplastic material of the plate portion becoming flowable at the interface to the metallic body. After re-solidification such connection will become tight again.

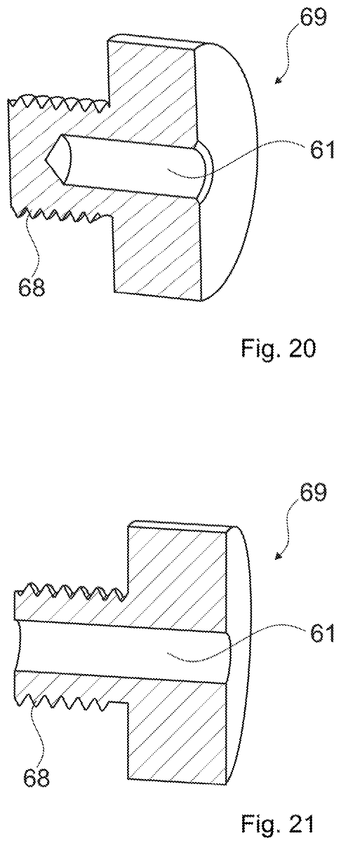

FIGS. 20 and 21 illustrate a further optional principle: The sonotrode may have an exchangeable sonotrode tip 69 that forms the distal outcoupling face (on the right hand side in FIGS. 19 and 20) and that has the axial channel 61 for accommodating the attachment structure. The axial channel 61 may be a blind hole open towards distally (FIG. 19) or an axially running through hole (FIG. 20).

Such sonotrode tip 36 may be mountable on a for example generic sonotrode body, for example via a sonotrode tip thread 68.

1. A connector configured to be anchored in a first object with thermoplastic material, the connector defining a proximodistal axis and comprising:
a plate portion extending around the proximodistal axis and having a proximal face and a distal face, the proximal face being adapted for a tool to be pressed against the proximal face;
an attachment structure accessible from the proximal side of the plate portion and/or an interaction element comprising a sensor and/or actuator;
an anchoring skirt protruding distally from the plate portion towards distally and radially outwardly, whereby an outer pocket open towards radially outwardly is formed between the distal face of the plate portion and a proximal face of the anchoring skirt, and an inner pocket open towards distally is formed radially inwardly of the anchoring skirt;
wherein the connector is capable of being anchored with respect to the first object by causing a tool to press the connector against the first object while the anchoring skirt is in physical contact with the first object and while mechanical energy is coupled into the connector until thermoplastic material of the first object flows relative to the connector and is caused to flow into the outer pocket and the inner pocket.

2. The connector according to claim 1, wherein the anchoring skirt forms an uninterrupted collar extending by 360°.

3. The connector according to claim 1, wherein the anchoring skirt extends around the proximodistal axis.

4. The connector according to claim 1, wherein the anchoring skirt is not rotationally symmetrical.

5. The connector according to claim 4, wherein the anchoring skirt is polygonal and/or comprises a pattern of radial indentations and/or protrusions.

6. The connector according to claim 1, wherein the anchoring skirt forms a distal edge, shaped to rest against a flat first object surface along a contact line defined by the edge.

7. The connector according to claim 6, wherein an edge angle of the edge is at most 120°.

8. The connector according to claim 1, comprising a flow hole having a mouth in the inner pocket, the flow hole extending from the mouth towards proximally.

9. The connector according to claim 1, wherein the attachment structure comprises an attachment bar having an outer thread.

10. The connector according to claim 1, wherein the plate portion extends radially further than the anchoring skirt.

11. The connector according to claim 1, wherein the inner pocket or a flow hole having a mouth in the inner pocket comprises at least one structure that is undercut with respect to axial directions.

12. The connector according to claim 1, wherein the attachment structure protrudes proximally from the proximal face of the plate portion.

13. The connector according to claim 1, wherein the plate portion is one-piece with the anchoring skirt.

14. The connector according to claim 1, wherein the plate portion is of a thermoplastic material and the anchoring skirt is of a not thermoplastic material or of a second thermoplastic material having a substantially higher liquefaction temperature than the thermoplastic material of the plate portion.

15. A method of bonding a connector in a first object with thermoplastic material, the method comprising the steps of:
providing the connector according to claim 1;
positioning the connector relative to the first object so that the anchoring skirt is in contact with thermoplastic material of the first object to yield an assembly comprising the connector and the first object;
using a tool to couple mechanical energy and a pressing force into the assembly until a flow portion of the thermoplastic material of the first object flows relative to the connector and is caused to flow into the outer pocket and the inner pocket, and stopping the mechanical energy, whereby after re-solidification of the flow portion the connector is anchored relative to the first object by the anchoring skirt being embedded in re-solidified thermoplastic material of the first object.

16. The method according to claim 15, wherein the mechanical energy is mechanical vibration energy.

17. The method according to claim 16, wherein the tool is a sonotrode, and wherein coupling the mechanical energy and the pressing force into the assembly comprises pressing a coupling-out face of the sonotrode against the proximal face of the plate portion while the sonotrode vibrates.

18. The method according to claim 16, wherein the tool is a sonotrode, and wherein coupling the mechanical energy and the pressing force into the assembly comprises pressing a coupling-out face of the sonotrode against a distal surface of the first object while the sonotrode vibrates and while the connector is held against the first object.

19. The method according to claim 18, wherein in the step of coupling the mechanical energy and the pressing force into the assembly, the connector is held by a third object to be secured to the first object.

20. A set, comprising the connector according claim 1 and further comprising a sonotrode or sonotrode tip, the sonotrode or sonotrode tip having a coupling-out face that is adapted to couple mechanical vibration and a pressing force into the connector via the proximal face of the plate portion.

21. The set according to claim 20, wherein the sonotrode or sonotrode tip has an axial channel for accommodating the attachment structure.
